(19) United States
(12) Patent Application Publication
(10) Pub. No.: US 2024/0430909 A1
(43) Pub. Date: Dec. 26, 2024

(54) METHODS AND APPARATUSES FOR PHYSICAL DOWNLINK SHARED CHANNEL RECEPTION

(71) Applicant: Lenovo (Beijing) Limited, Beijing (CN)

(72) Inventors: Yu Zhang, Beijing (CN); Haipeng Lei, Beijing (CN)

(73) Assignee: Lenovo (Beijing) Limited, Beijing (CN)

(21) Appl. No.: 18/700,919

(22) PCT Filed: Oct. 13, 2021
(86) PCT No.: PCT/CN2021/123568

§ 371 Date: Apr. 12, 2024

(51) Int. Cl. H04W 72/232; H04B 7/06

(52) U.S. Cl. CPC H04W 72/232; H04B 7/06952

(57) ABSTRACT

Methods and apparatuses are provided for determining at least one TCI state to be used according to listen-before-transmit (LBT) result. Methods comprises: receiving a first downlink control information (DCI) scheduling at least one physical downlink shared channel (PDSCH) reception including a first PDSCH reception from a base station (BS), wherein the first DCI indicates at least two groups of demodulation reference signal (DMRS) ports and at least two transmission configuration indication (TCI) states for the first PDSCH reception; and determine at least one TCI state of the at least two TCI states, wherein the at least one TCI state is associated with at least one sensing beam where listen-before-transmit (LBT) procedures performed by the BS generate a success result.

### TECHNICAL FIELD

The present disclosure generally relates to wireless communication technologies, and especially to methods and apparatuses for data reception on unlicensed bands.

### BACKGROUND OF THE INVENTION

For network of 3GPP (3^{rd} Generation Partnership Project) 5G NR (New Radio), technologies of data transmission on unlicensed bands are developed. When unlicensed bands are used for data transmission(s), channel access procedures (e.g., Listen-Before-Talk procedures, LBT procedures) may be required to be performed by the transmitting device, for example a base station (BS). The LBT procedures are executed by performing energy detection on a certain channel. Only when the LBT procedures generate a success result can the transmitting device perform data transmission(s) on the certain channel.

Conventional omni-directional LBT procedures may cause some issues when operated on the unlicensed bands around 60 GHz, of which the biggest one is over protection. To improve the probability of successful channel access and to enhance the spatial reuse, directional LBT procedures, which are executed by performing energy detection with one or more sensing beams, are introduced. The one or more sensing beams may also be referred to as LBT beams. According to the results of the LBT procedures with one or more sensing beams, the transmitting device can determine a spatial region, and a transmission (Tx) beam used by the transmitting device to perform a transmission on the channel should be within the spatial region, that is, the one or more sensing beams should cover the Tx beam.

### SUMMARY

Various embodiments and methods of the present disclosure provide solutions related to PDSCH (Physical downlink shared channel) reception on unlicensed bands.

According to some embodiments of the present disclosure, an exemplary method performed by a UE (User equipment) is provided. The method includes: receiving a first DCI (downlink control information) scheduling at least one PDSCH reception including a first PDSCH reception from a BS (Base station), wherein the first DCI indicates at least two groups of demodulation reference signal (DMRS) ports and at least two transmission configuration indication (TCI) states for the first PDSCH reception; and determining at least one TCI state of the at least two TCI states, wherein the at least one TCI state is associated with at least one sensing beam where listen-before-transmit (LBT) procedures performed by the BS generate a success result.

In some embodiments, the method further includes performing a second PDSCH reception instead of the first PDSCH reception based on the determined at least one TCI state.

In some embodiments, the LBT procedures are performed by the BS with at least two sensing beams associated with the at least two TCI states.

In some embodiments, the determination of the at least one TCI state further comprises: detecting PDSCH transmission based on the at least two TCI states; and determining the at least one TCI state of the at least two TCI states based on the detection.

In some embodiments, the determination of the at least one TCI state further comprises: receiving a second DCI; and determining the at least one TCI state based on the second DCI.

In some embodiments, the second DCI is generated by the BS after the LBT is performed by the BS.

In some embodiments, the second DCI indicates the at least one sensing beam where the LBT procedures performed by the BS generate a success result.

According to some embodiments of the present disclosure, an exemplary method performed by a BS is provided. The method includes: transmitting a first DCI scheduling at least one PDSCH transmission including a first PDSCH transmission to a UE, wherein the first DCI indicates at least two groups of DMRS ports and at least two TCI states for the first PDSCH transmission; performing LBT procedures with at least two sensing beams after the transmission of the first DCI, wherein the at least two sensing beams are associated with the at least two TCI states; and determining at least one TCI state of the at least two TCI states that is associated with at least one sensing beam where LBT procedures generate a success result.

In some embodiments, the method further includes performing a second PDSCH transmission instead of the first PDSCH transmission based on the determined at least one TCI state.

In some embodiments, the method further includes transmitting a second DCI, wherein the second DCI indicates the at least one sensing beam where the LBT procedures generate a success result.

In some embodiments, the method further includes generating the second DCI after performing the LBT.

In some embodiments, the second DCI indicates the at least one sensing beam where the LBT procedures generate a success result.

According to some embodiments of the present disclosure, an exemplary UE is provided. The UE includes a processor and a wireless transceiver coupled to the processor, the processor is configured to receive a first DCI scheduling at least one PDSCH reception including a first PDSCH reception from a BS, wherein the first DCI indicates at least two groups of DMRS ports and at least two TCI states for the first PDSCH reception; and determining at least one TCI state of the at least two TCI states, wherein the at least one TCI state is associated with at least one sensing beam where LBT procedures performed by the BS generate a success result.

In some embodiment, the processor is further configured to perform a second PDSCH reception instead of the first PDSCH reception based on the determined at least one TCI state.

In some embodiments, the LBT procedures are performed by the BS with at least two sensing beams associated with the at least two TCI states.

In some embodiments, to determine the at least one TCI state, the processor is further configured to: detect PDSCH transmission based on the at least two TCI states, and determine the at least one TCI state of the at least two TCI states based on the detection.

In some embodiment, to determine the at least one TCI state, the processor is further configured to receive a second DCI and determine the at least one TCI state based on the second DCI.

In some embodiment, the second DCI is generated by the BS after the LBT is performed by the BS.

In some embodiment, the second DCI indicates the at least one sensing beam where the LBT procedures performed by the BS generate a success result.

According to some embodiments of the present disclosure, an exemplary BS is provided. The BS includes a processor and a wireless transceiver coupled to the processor, the processor is configured to: transmit a first DCI scheduling at least one PDSCH transmission including a first PDSCH transmission to a UE, wherein the first DCI indicates at least two groups of DMRS ports and at least two TCI states for the first PDSCH transmission; perform LBT procedures with at least two sensing beams after the transmission of the first DCI, wherein the at least two sensing beams are associated with the at least two TCI states; and determine at least one TCI state of the at least two TCI states that is associated with at least one sensing beam where LBT procedures generate at least one success result.

In some embodiments, the processor is further configured to perform a second PDSCH transmission instead of the first PDSCH transmission based on the determined at least one TCI state.

In some embodiments, the processor is further configured to transmit a second DCI, wherein the second DCI indicates the at least one sensing beam where the LBT procedures generate a success result.

In some embodiments, the processor is further configured to generate the second DCI after performing the LBT.

In some embodiments, the second DCI indicates the at least one sensing beam where the LBT procedures generate a success result.

### BRIEF DESCRIPTION OF THE DRAWINGS

In order to describe the manner in which advantages and features of the present disclosure can be obtained, a description of the present disclosure is rendered by reference to specific embodiments thereof which are illustrated in the appended drawings. These drawings depict only exemplary embodiments of the present disclosure and are not therefore intended to limit the scope of the present disclosure.

FIG. 1 illustrates exemplary directional LBT procedures performed by a BS with one or more sensing beams;

FIG. 2 illustrates an exemplary flowchart of a method according to some embodiments of the present disclosure;

FIG. 3 illustrates an exemplary flowchart of a method according to some embodiments of the present disclosure;

FIG. 4 illustrates an exemplary flowchart of a method according to some embodiments of the present disclosure;

FIG. 5 illustrates an exemplary signaling flow chart according to an exemplary method of the present disclosure;

FIG. 6 illustrates an exemplary flowchart of a method according to some embodiments of the present disclosure;

FIG. 7 illustrates a simplified block diagram of an exemplary apparatus according to some embodiments of the present disclosure; and

FIG. 8 illustrates a simplified block diagram of an exemplary apparatus according to some other embodiments of the present disclosure.

### DETAILED DESCRIPTION

The detailed description of the appended drawings is intended as a description of the currently preferred embodiments of the present invention and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order shown or in sequential order, or that among all illustrated operations be performed, to achieve desirable results, sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as 3GPP 5G NR, 3GPP long-term evolution (LTE), and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

In some embodiments of the present disclosure, UEs may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), road side units (RSUs), or the like. According to an embodiment of the present disclosure, the UE may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the UE may include wearable devices, such as smart watches, fitness bands, optical head-mounted displays, or the like. Moreover, the UE may be referred to as a subscriber unit, a mobile, a mobile station, a user, a terminal, a mobile terminal, a wireless terminal, a fixed terminal, a subscriber station, a user terminal, or a device, or described using other terminology used in the art.

In some embodiments of the present disclosure, a BS may be referred to as an access point, an access terminal, a base, a base unit, a macro cell, a Node-B, an enhanced Node-B, an evolved Node B (eNB), a next generation Node B (gNB), a Home Node-B, a relay node, or a device, or described using other terminology used in the art. The BS is generally part of a radio access network that may include a controller communicably coupled to the BS.

A BS may schedule a PDSCH transmission to a UE for data transmission by a DCI. The data may be mapped onto one or more layers of the PDSCH. A PDSCH layer corresponds to a set of time-frequency resource. The UE can receive and decode the PDSCH according to the information carried in the DCI, for example, the DMRS port corresponding to each PDSCH layer and the TCI state.

A BS may use multiple Transmission and Reception Points (TRPs) or panels for PDSCH transmission; accordingly, the BS may transmit PDSCH simultaneously from two geographically separated TRPs, wherein a TRP can act like a small BS and is used to serve one or more UEs under control of the BS. In different scenarios, the TRP may be referred to as different terms. Persons skilled in the art should understand that as the 3GPP and the communication technology develop, the terminologies recited in the specification may change, which should not affect the scope of the present disclosure. It should be understood that the TRPs or panels configured for the BS may be transparent to a UE.

More specifically, 3GPP 5G NR supports that a single DCI schedules a single multi-layer PDSCH where different PDSCH layers may be transmitted from different TRPs. In this case, multiple groups of DMRS ports can be indicated in the DCI, and each group of DMRS ports corresponds to a TRP. A group of DMRS ports may consist of multiple DMRS ports, and each DMRS port corresponds to a layer of the PDSCH. The PDSCH layers corresponding to the same group of DMRS ports are transmitted from the same TRP.

For a UE receiving a PDSCH, the downlink (DL) transmission (Tx) beam used for the PDSCH transmission by the BS can be dynamically indicated in the scheduling DCI by indicating a specific TCI state. The TCI state can provide Quasi Co-Location (QCL) information corresponding to a DL Tx beam, so that the UE can identify the DL Tx beam according to the received TCI state.

To support multi-TRP transmission as described above, the mechanism for a DCI to simultaneously indicate multiple different TCI states is introduced and each TCI state corresponds to a group of DMRS ports which is corresponding to a TRP, so that the BS can indicate the DL Tx beam used for the corresponding PDSCH layer transmission(s) from the corresponding TRP.

When operating multi-TRP transmission on unlicensed bands, the BS may need to perform directional LBT procedures with multiple sensing beams covering the multiple Tx beams, the directional LBT procedures with different sensing beams may be performed in Time-Division Multiplexing (TDM) fashion or may be performed simultaneously.

If the directional LBT procedures with one of the sensing beams covering a Tx beam, which is used for PDSCH layers transmission from a TRP, generate a failure result, the PDSCH layers cannot be transmitted from the TRP, in this case, even the other PDSCH layers transmitted from other TRPs are received by the UE, the whole PDSCH may not be decoded correctly.

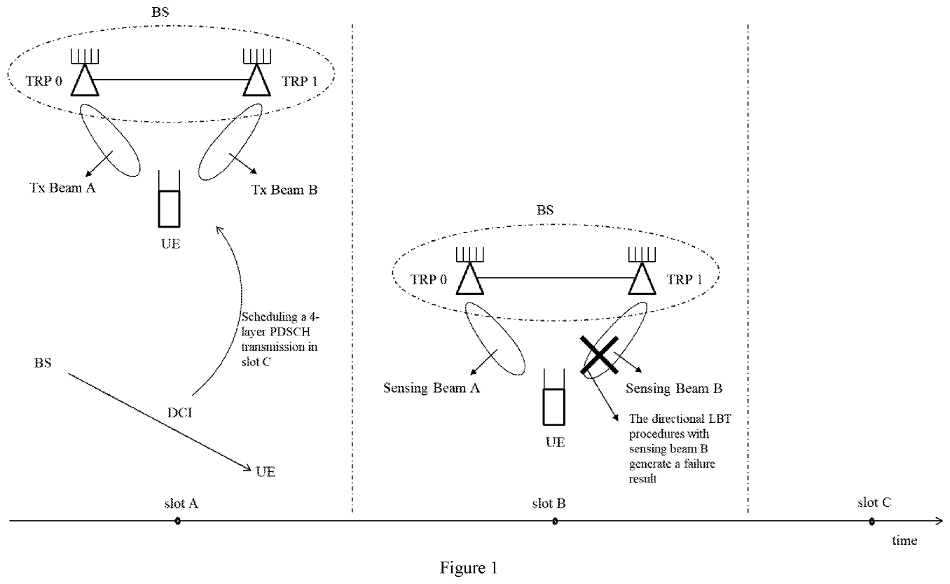

FIG. 1 illustrates an example that the directional LBT procedures with one of the sensing beams generate a failure result.

In slot A, a UE receives a DCI scheduling a 4-layer PDSCH transmission in slot C from two TRPs (TRP 0 and TRP 1, as illustrated in FIG. 1) of a BS. The DCI indicates two groups of DMRS ports for the PDSCH transmission, more specifically, group 0 of DMRS ports consists of DMRS port 0 and DMRS port 1 while group 1 of DMRS ports consists of DMRS port 2 and DMRS port 3. The DCI also indicates TCI state 0 (corresponding to Tx beam A) and TCI state 1 (corresponding to Tx beam B). Herein TRP0 corresponds to TCI state 0 and group 0 of DMRS ports, and TRP1 corresponds to TCI state 1 and group 1 of DMRS ports.

Then in slot B, the BS starts performing directional LBT procedures with sensing beam A and sensing beam B which cover Tx beam A and Tx beam B respectively, wherein Tx beam A and Tx beam B are used for the corresponding PDSCH layers transmissions from the corresponding TRPs. If the directional LBT procedures with sensing beam A generate a success result while the directional LBT procedures with sensing beam B generate a failure result, the corresponding PDSCH layers, that is, the PDSCH layers corresponding to DMRS port 2 and DMRS port 3 cannot be transmitted with Tx beam B, in this case, even the other PDSCH layers can be transmitted with Tx beam A and are received by the UE, the whole PDSCH may not be decoded correctly by the UE.

The present disclosure provides solutions to resolve the above issue for multi-layer PDSCH transmission and reception, i.e., if the directional LBT procedures with one of the sensing beams generate a failure result, how a multi-layer PDSCH transmission and reception can then be performed.

According to the present disclosure, the UE will perform new PDSCH reception procedures.

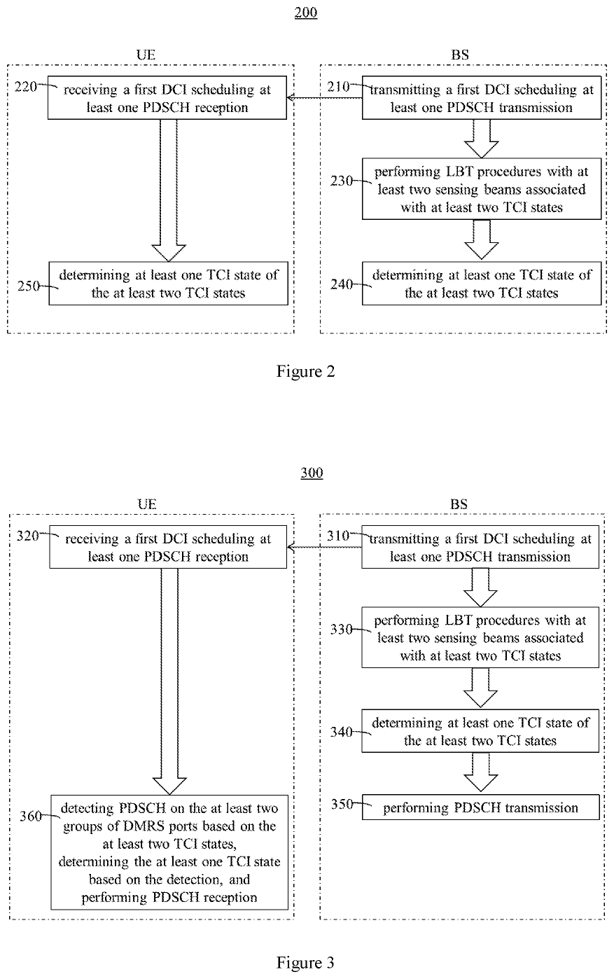

FIG. 2 illustrates an exemplary flowchart of method 200 for multi-layer PDSCH transmission and reception via multiple TRPs on unlicensed bands, according to some embodiments of the present disclosure. Although method 200 performed by a UE and a BS is illustrated in a system level, persons skilled in the art can understand that the part of method 200 implemented in the UE and the part of method 200 implemented in the BS can be separately implemented and incorporated in other apparatus with the like functions.

It would be appreciated that in method 200 or in other methods described later, the UE is not a special UE; it can be a generic device or an apparatus, or a part of a device or an apparatus that uses the technical solution of the present application.

It would be appreciated that in method 200 or in other methods described later, the BS is not a special BS; it can be a generic BS or even a part of a BS that uses the technical solution of the present application.

In operation 210, a BS transmits a first DCI scheduling at least one PDSCH transmission to a UE, wherein the first DCI indicates at least two groups of DMRS ports corresponding to at least two TRPs, and at least two TCI states corresponding to at least two Tx beams for the at least one PDSCH transmission. Correspondingly, in operation 220, the UE receives the first DCI from the BS.

After transmitting the first DCI, in operation 230, the BS performs LBT procedures with at least two sensing beams covering the at least two Tx beams corresponding to the at least two indicated TCI states.

In operation 240, the BS determines that at least one Tx beam can be used for the at least one PDSCH transmission according to the success result generated by the LBT procedures with the at least one sensing beam covering the at least one Tx beam in operation 230, that is, the BS determines at least one TCI state of the at least two TCI states, wherein the at least one TCI state is associated with the at least one sensing beam where LBT procedures generate a success results.

In operation 250, the UE may also determine the same at least one TCI state of the at least two TCI states, wherein the at least one TCI state is associated with the at least one sensing beam where LBT procedures performed by the BS generate a success result.

Specifically, in operation 210, the BS transmits a first DCI scheduling N (an integer>=1) PDSCH transmissions from M (an integer>=2) TRPs, the first DCI indicates M groups of DMRS ports corresponding to the M TRPs, and indicates at least one TCI state for each of the N PDSCH transmissions from each TRP, i.e., the first DCI indicates M Tx beams corresponding to M TRPs receptively which are used by the BS for each of the N PDSCH transmissions; herein group 0 of DMRS ports consists of P₀ DMRS ports, group 1 of DMRS ports consists of P₁ DMRS ports, . . . , and group (M−1) of DMRS ports consists of P_{(M-1)} DMRS ports; it means that the number of layers of each PDSCH is (P₀+P₁+ . . . +P_{(M-1)}); herein P₀, P₁, . . . , P_{(M-1)} are positive integers. In operation 220, the UE receives the first DCI.

After transmitting the first DCI and before transmitting the N PDSCH transmissions, in operation 230, the BS performs directional LBT procedures with M sensing beams which cover the M DL Tx beams.

If the LBT procedures with all the M sensing beams generate success results in the operation 230, then in operation 240, the BS determines that all the Tx beams, each of which corresponds to an indicated TCI state, can be used for the N PDSCH transmissions; then the BS may transmit the N PDSCH transmissions at the time scheduled by the first DCI, wherein each PDSCH having (P₀+P₁+ . . . +P_{(M-1)}) layers.

If the LBT procedures with some sensing beam(s) in the operation 230 generate failure results, then in operation 240, the BS determines at least one Tx beams can be used for the N PDSCH transmissions according to the success result generated by the LBT procedures with the at least one sensing beam covering the at least one Tx beam, that is, the BS determine at least one TCI state of the indicated TCI states, wherein the at least one TCI state is associated with the at least one sensing beam where LBT procedures generate a success results. Subsequently, the BS generates N new PDSCH transmissions instead of the N original PDSCH transmissions (each having (P₀+P₁+ . . . +P_{(M-1)}) layers), and each new PDSCH transmission has (P₀+P₁+ . . . +P_{(M-1)}−P_{failure}) layers; herein P_{failure} is a sum of the numbers of DMRS ports of the groups of DMRS ports which are associated with the TCI states corresponding to the sensing beams where the LBT procedures generate failure results.

In operation 250, the UE will also determine the same at least one TCI state of the indicated TCI states that is associated with the at least one sensing beam where LBT procedures performed by the BS generate a success result.

If the LBT procedures with all the M sensing beams in operation 230 generate success results, then in operation 250, the UE determines that all the M Tx beams, each of which corresponds to the TCI state, can be used for the PDSCH transmissions; then the UE may receive the N PDSCH transmissions at the time scheduled by the first DCI, each PDSCH having (P₀+P₁+ . . . +P_{(M-1)}) layers.

If the LBT procedures with some sensing beams in operation 230 generate failure results, then in operation 250, the UE determines the same at least one TCI state of the indicated TCI states that is associated with the at least one sensing beam where LBT procedures performed by the BS generate a success result; subsequently, the UE may receive N new PDSCH transmissions instead of the N original PDSCHs (each having (P₀+P₁+ . . . +P_{(M-1)}) layers) at the time scheduled by the first DCI, each new PDSCH has (P₀+P₁+ . . . +P_{(M-1)}−P_{failure}) layers; herein P_{failure} is a sum of the numbers of DMRS ports of the groups of DMRS ports, which are associated with the TCI states corresponding to the sensing beams where the LBT procedures generate failure results.

For example, referring back to FIG. 1 in combination with FIG. 2, in operation 210, in slot A, a BS transmits a first DCI (i.e., the DCI illustrated in FIG. 1) scheduling a 4-layer PDSCH transmission (N=1) in slot C from two TPRs (TRP 0 and TRP 1) (M=2) to a UE. The first DCI indicates two groups of DMRS ports for the PDSCH transmission, more specifically, group 0 of DMRS ports consists of DMRS port 0 and DMRS port 1 and group 1 of DMRS ports consists of DMRS port 2 and DMRS port 3. The first DCI also indicates TCI state 0 (corresponding to Tx beam A) and TCI state 1 (corresponding to Tx beam B). Herein, TRP 0 corresponds to TCI state 0 and group 0 of DMRS ports, and TRP 1 corresponds to TCI state 1 and group 1 of DMRS ports. Correspondingly, in operation 220, the UE receives the first DCI.

In operation 230 during slot B, before transmitting the PDSCH, the BS performs directional LBT procedures with both sensing beam A and sensing beam B which cover Tx beam A and B respectively, wherein Tx beam A and Tx beam B are used for the 4-layer PDSCH transmission.

If the directional LBT procedures with both the sensing beam A and the sensing beam B generate success results, then in operation 240, the BS may determine that both Tx beam A and Tx beam B corresponding to TCI state 0 and TCI state 1 can be used for the PDSCH transmission; correspondingly, in operation 250, the UE may also determine TCI state 0 and TCI state 1. Later, the BS may transmit the 4-layer PDSCH in slot C via TRP 0 and TRP 1, and the UE may receive the 4-layer PDSCH in slot C.

If the directional LBT procedures with sensing beam A generate a success result while the directional LBT procedures with sensing beam B generate a failure result, then in operation 240, the BS may determine that Tx beam A corresponding to TCI state 0 may be used for PDSCH transmission, while Tx beam B corresponding to TCI state 1 cannot be used for PDSCH transmission, that is, the BS determine TCI state 0, which is associated with the sensing beam A where LBT procedures generate a success results; correspondingly, in operation 250, the UE may also determine only TCI state 0. According to the present disclosure, the BS may generate a new 2-layer PDSCH and transmit the new 2-layer PDSCH instead of the 4-layer PDSCH in slot C via TRP 0, and the UE may receive the new 2-layer PDSCH instead of the 4-layer PDSCH in slot C. In this example, P_{failure} is 2.

According to the present disclosure, in operation 250, the UE needs to know the results generated by the LBT procedures on the BS side, i.e., the UE needs to determine which Tx beam(s) can be used by the BS to transmit the PDSCH; otherwise, the UE cannot make a correct determination in operation 250.

Hereinafter various methods and embodiments are provided based on method 200 according to the present disclosure to notify the results generated by the LBT procedures on the BS side.

FIG. 3 illustrates an exemplary flowchart of method 300 (based on method 200) for multi-layer PDSCH transmission and reception via multiple TRPs on unlicensed bands, according to some embodiments of the present application. In method 300, the UE gets to know the results generated by the LBT procedures on the BS side via detecting PDSCH transmission based on the at least two TCI states.

Although the method 300 performed by a UE and a BS is illustrated in a system level, persons skilled in the art can understand that the part of method 300 implemented in the UE and the part of method 300 implemented in the BS can be separately implemented and incorporated in other apparatus with the like functions.

It would be appreciated that in method 300 or in other methods described later, the UE is not a special UE; it can be a generic device or an apparatus, or a part of a device or an apparatus that uses the technical solution of the present application.

It would be appreciated that in method 300 or in other methods described later, the BS is not a special BS; it can be a generic BS or even a part of a BS that uses the technical solution of the present application.

In operation 310, a BS transmits a first DCI scheduling at least one PDSCH transmission to a UE, wherein the first DCI indicates at least two groups of DMRS ports corresponding to at least two TRPs, and indicates at least two TCI states corresponding to at least two Tx beams for the at least one PDSCH transmission. For example, the BS transmits a first DCI scheduling N PDSCH transmissions from M TRPs, the first DCI indicates M groups of DMRS ports corresponding to the M TRPs, and indicates at least one TCI state for each of the N PDSCH transmissions from each TRP, i.e., the first DCI indicates M DL Tx beams corresponding to M TRPs receptively which are used by the BS for each of the N PDSCH transmissions; herein group 0 of DMRS ports consists of P₀ DMRS ports, group 1 of DMRS ports consists of P₁ DMRS ports, . . . , group (M−1) of DMRS ports consists of P_{(M-1)} DMRS ports (P₀, P₁ . . . P_{(M-1)} are positive integer); it means that the number of layers of each PDSCH is (P₀+P₁+ . . . +P_{(M-1)}). In operation 320, the UE receives the first DCI from the BS.

After transmitting the first DCI and before transmitting the N PDSCH transmissions, in operation 330, the BS performs LBT procedures with M sensing beams covering the M Tx beams.

If the LBT procedures with all the M sensing beams generate success results in the operation 330, then in operation 340, the BS determines that all the Tx beams, each of which corresponds to an indicated TCI state, can be used for the N PDSCH transmission; then in operation 350, the BS may transmit the N PDSCH transmissions scheduled by the first DCI, each PDSCH having (P₀+P₁+ . . . +P_{(M-1)}) layers. On the other hand, in operation 360, the UE detects the PDSCH transmission(s) based on the M DL Tx beams corresponding to the indicated TCI states in the first DCI, that is, detects the PDSCH transmission(s) based on the indicated TCI states, and then determines all the indicated TCI states and receives the N PDSCH transmissions each having (P₀+P₁+ . . . +P_{(M-1)}) layers.

If the LBT procedures with some sensing beams in the operation 330 generate failure results, then in operation 340, the BS determines the at least one Tx beam can be used for the N PDSCH transmissions according to the success result generated by the LBT procedures with the at least one sensing beam covering the at least one Tx beam, that is, the BS determine at least one TCI state of the indicated TCI states, wherein the at least one TCI state is associated with the at least one sensing beam where LBT procedures generate a success results,; then in operation 350, the BS generates and transmits N new PDSCH transmissions instead of the N original PDSCH transmissions (each having (P₀+P₁+ . . . +P_{(M-1)}) layers), and each new PDSCH transmission has (P₀+P₁+ . . . +P_{(M-1)}−P_{failure}) layers, herein P_{failure} is a sum of the numbers of DMRS ports of the groups of DMRS ports which are associated with the TCI states corresponding to the sensing beams where the LBT procedures generate failure results. For the sensing beam(s) where the LBT procedures generate failure result(s), the BS will not perform PDSCH transmission from the associated TRP(s).

On the other hand, after reception of the first DCI, in operation 360, the UE detects PDSCH transmission(s) based on the indicated TCI states. Regarding the TRP(s) that are not used for PDSCH transmissions by the BS in the operation 350, the UE cannot detect the transmissions of the PDSCH layers associated with the groups of DMRS ports corresponding to the TRP(s); based on the detection, in operation 360, the UE determines the same at least one TCI state of the indicated TCI states, and performing PDSCH reception.

Specifically, in operation 360, if the UE detects the transmissions of the PDSCH layers associated with all the groups of DMRS ports, each of which corresponding to a TRP and a TCI state, at the time scheduled by the first DCI, the UE determines that all the TCI states, and receives the N PDSCHs having (P₀+P₁+ . . . +P_{(M-1)}) layers.

However, if the UE cannot detects the transmissions of the PDSCH layers associated with some groups of DMRS ports, each of which corresponding to a TRP and a TCI state, it may determine that the LBT procedures performed by the BS with some sensing beams generate some failure results, and determine the same at least one TCI state as the BS in operation 340. The UE gets to know that N new PDSCH transmissions are performed by the BS. Since the UE can detect the transmissions of the PDSCH layers associated with (P₀+P₁+ . . . +P_{(M-1)}−P_{failure}) DMRS ports, the UE try to decode the new N PDSCH transmissions each having (P₀+P₁+ . . . +P_{(M-1)}−P_{failure}) layers.

For example, referring back to FIG. 1 in combination with FIG. 3, in operation 310, in slot A, a BS transmits a first DCI (i.e., the DCI illustrated in FIG. 1) scheduling a 4-layer PDSCH transmission (N=1) in slot C from two TPRs (TRP 0 and TRP 1) (M=2) to a UE. The first DCI indicates two groups of DMRS ports for the PDSCH transmission, more specifically, group 0 of DMRS ports consists of DMRS port 0 and DMRS port 1 and group 1 of DMRS ports consists of DMRS port 2 and DMRS port 3. The first DCI also indicates TCI state 0 (corresponding to Tx beam A) and TCI state 1 (corresponding to Tx beam B). Herein, TRP 0 corresponds to TCI state 0 and group 0 of DMRS ports, and TRP 1 corresponding to TCI state 1 and group 1 of DMRS ports. Correspondingly, in operation 320, the UE receives the first DCI.

In operation 330 during slot B, before transmitting the 4-layer PDSCH, the BS performs directional LBT procedures with both sensing beam A and sensing beam B which cover Tx beam A and Tx beam B respectively, wherein Tx beam A and Tx beam B are used for the 4-layer PDSCH transmission.

If the directional LBT procedures with both the sensing beam A and the sensing beam B generate success results, then in operation 340, the BS may determine that both the Tx beam A and Tx beam B corresponding to the two TCI states can be used for the 4-layer PDSCH transmission; Later, the BS may transmit the 4-layer PDSCH in slot C via TRP 0 and TRP 1; in this case, P_{failure} is 0. On the other hand, during slot C, in operation 360, the UE may also determine that TCI state 0 and TCI state 1 based on the detection of the PDSCH transmission(s), and receives the 4-layer PDSCH.

If the directional LBT procedures with sensing beam A generate a success result while the directional LBT procedures with sensing beam B generate a failure result, then in operation 340, the BS may determine the Tx beam A corresponding to TCI state 0 can be used for PDSCH transmission, while the Tx beam B corresponding to TCI state 1 cannot be used for PDSCH transmission, that is, the BS determines TCI state 0, which is associated with the sensing beam A where LBT procedures generate a success results; then in operation 350, the BS generates a new 2-layer PDSCH and transmit the new 2-layer PDSCH instead of the 4-layer PDSCH in slot C via TRP 0; in this case, P_{failure} is 2.

On the other hand, in slot C, the UE can only detect the transmissions of the PDSCH layers associated with group 0 of DMRS ports, then the UE also determines only TCI state 0, and tries to decode the new 2-layer PDSCH instead of the 4-layer PDSCH.

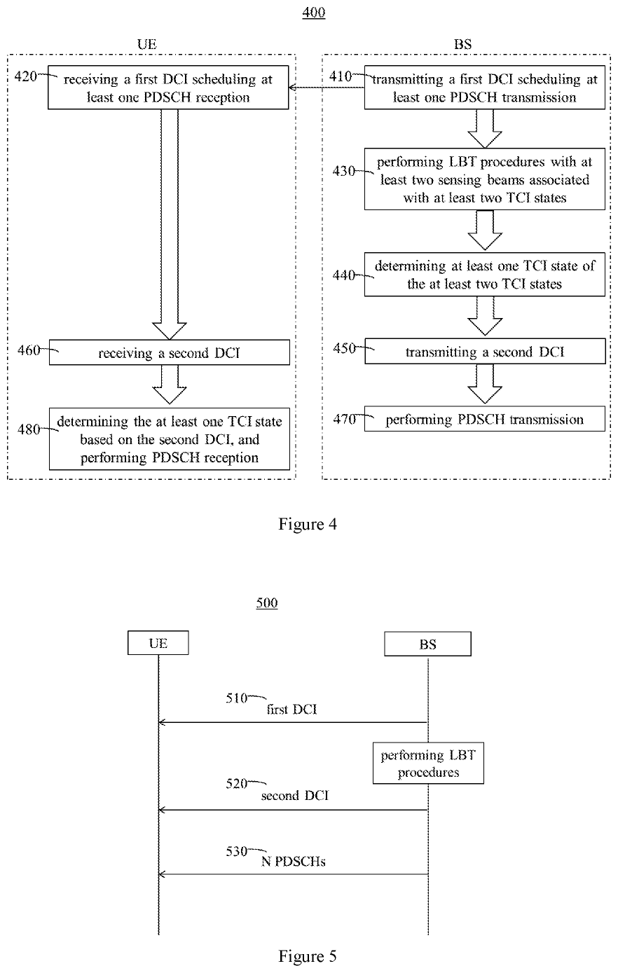

FIG. 4 illustrates another exemplary flowchart of method 400 (based on method 200) for multi-layer PDSCH transmission and reception via multi-TRP on unlicensed bands according to some embodiments of the present application. In method 400, the UE gets to know results generated by the LBT procedures on the BS side according to a second DCI, herein the second DCI is generated by the BS based on the results generated by the LBT procedures.

Although method 400 performed by a UE and a BS is illustrated in a system level, persons skilled in the art can understand that the part of method 400 implemented in the UE and the part of method 400 implemented in the BS can be separately implemented and incorporated in other apparatus with the like functions.

It would be appreciated that in method 400 or in other methods described later, the UE is not a special UE; it can be a generic device or an apparatus, or a part of a device or an apparatus that uses the technical solution of the present application.

It would be appreciated that in method 400 or in other methods described later, the BS is not a special BS; it can be a generic BS or even a part of a BS that uses the technical solution of the present application.

In operation 410, a BS transmits a first DCI scheduling at least one PDSCH transmission including a first PDSCH transmission to a UE, wherein the first DCI indicates at least two groups of DMRS ports corresponding to at least two TRPs, and indicates at least two TCI states corresponding to at least two Tx beams for the at least one PDSCH transmission. For example, the BS transmits a first DCI scheduling N PDSCH transmissions from M TRPs, the first DCI indicates M groups of DMRS ports corresponding to the M TRPs, and indicates at least one TCI state for each of the N PDSCH transmissions from each TRP, i.e., the first DCI indicates M Tx beams corresponding to M TRPs receptively which are used by the BS for each of the N PDSCH transmissions; herein group 0 of DMRS ports consists of P₀ DMRS ports, group 1 of DMRS ports consists of P₁ DMRS ports, . . . , group (M−1) of DMRS ports consists of P_{(M-1)} DMRS ports (P₀, P₁ . . . P_{(M-1)} are positive integer); it means that the number of layers of each PDSCH is (P₀+P₁+ . . . +P_{(M-1)}). Correspondingly, in operation 420, the UE receives the first DCI from the BS.

After transmitting the first DCI and before transmitting the N PDSCH transmissions, in operation 430, the BS performs LBT procedures with M sensing beams covering the M Tx beams.

If the LBT procedures with all the M sensing beams generate success results in the operation 430, then in operation 440, the BS determines that all the Tx beams, each of which corresponds to an indicated TCI state, can be used for the N PDSCH transmissions; then in operation 450, the BS transmits a second DCI indicating the M sensing beams (e.g., indicating the TCI states corresponding to the M sensing beams). Correspondingly, in operation 460, the UE receives the second DCI. Then in operation 470, the BS may transmit the N PDSCH transmissions scheduled by the first DCI, each PDSCH having (P₀+P₁+ . . . +P_{(M-1)}) layers. On the other hand, in operation 480, the UE determines that all the M Tx beams which are covered by the M sensing beams can be used for the PDSCH transmission, that is, the UE determines all the TCI states according to the second DCI, and receives the N PDSCH transmissions each having (P₀+P₁+ . . . +P_{(M-1)}) layers.

If the LBT procedures with some sensing beams in the operation 430 generate failure results, then in operation 440, the BS determines at least one Tx beam can be used for the N PDSCH transmissions according to the success result generated by the LBT procedures with the at least one sensing beam covering the at least one Tx beam, that is, the BS determines at least one TCI state of the indicated TCI states, wherein the at least one TCI state is associated with the at least one sensing beam where LBT procedures generate a success results; then in operation 450, the BS transmits a second DCI which indicates the at least one sensing beam where LBT procedures generate a success result. Then in operation 470, the BS generates and transmits N new PDSCH transmissions instead of the N original PDSCH transmissions (each having (P₀+P₁+ . . . +P_{(M-1)}) layers), and each new PDSCH transmission has (P₀+P₁+ . . . +P_{(M-1)}−P_{failure}) layers, herein P_{failure} is a sum of the numbers of DMRS ports of the groups of DMRS ports which are associated with the TCI states corresponding to the sensing beams where the LBT procedures generate failure results.

On the other hand, in operation 460, the UE receives the second DCI indicating the at least one sensing beam where LBT procedures generate a success result, then in operation 480, the UE determines that at least one Tx beam (corresponding to at least one TCI state) which is covered by the at least one sensing beam can be used for the PDSCH transmission, that is, the UE determines the same at least one TCI state which is associated with the at least one sensing beam indicated in the second DCI, and receives the N new PDSCH transmissions each having (P₀+P₁+ . . . +P_{(M-1)}−P_{failure}) layers at the time scheduled by the first DCI.

For example, referring back to FIG. 1 in combination with FIG. 4, in operation 410, in slot A, a BS transmits a first DCI (i.e., the DCI illustrated in FIG. 1) scheduling a 4-layer PDSCH transmission (N=1) in slot C from two TPRs (TRP 0 and TRP 1) (M=2) to a UE. The first DCI indicates two groups of DMRS ports for the PDSCH transmission, more specifically, group 0 of DMRS ports consists of DMRS port 0 and DMRS port 1 and group 1 of DMRS ports consists of DMRS port 2 and DMRS port 3. The first DCI also indicates TCI state 0 (corresponding to Tx beam A) and TCI state 1 (corresponding to Tx beam B). Herein, TRP 0 corresponds to TCI state 0 and group 0 of DMRS ports, and TRP 1 corresponds to TCI state 1 and group 1 of DMRS ports. Correspondingly, in operation 420, the UE receives the first DCI.

In operation 430 during slot B, before transmitting the 4-layer PDSCH, the BS performs directional LBT procedures with both sensing beam A and sensing beam B which cover Tx beam A and Tx beam B respectively, wherein Tx beam A and Tx beam B are used for the 4-layer PDSCH transmission.

If the directional LBT procedures with both the sensing beam A and the sensing beam B generate success results, then in operation 440, the BS determines that both the Tx beam A and Tx beam B corresponding to the two TCI states can be used for the 4-layer PDSCH transmission; then in operation 450, the BS transmits a second TCI indicating the two sensing beams; and in operation 470, the BS transmit the 4-layer PDSCH in slot C via TRP 0 and TRP 1; in this case, P_{failure} is 0. Correspondingly, in operation 460, the UE receives the second DCI, and then in operation 480, the UE determines TCI state 0 and TCI state 1 according to the second DCI, and receives the 4-layer PDSCH in slot C.

If the directional LBT procedures with sensing beam A generate a success result while the directional LBT procedures with sensing beam B generate a failure result, then in operation 440, the BS may determine the Tx beam A corresponding to TCI state 0 can be used for PDSCH transmission, while the Tx beam B corresponding to TCI state 1 cannot be used for PDSCH transmission, that is, the BS determines TCI state 0, which is associated with the sensing beam A where LBT procedures generate a success results; then in operation 450, the BS transmits a second DCI indicating the sensing beam A, and in operation 470, the BS generates a new 2-layer PDSCH and transmit the new 2-layer PDSCH instead of the 4-layer PDSCH in slot C via TRP 0; in this case, P_{failure} is 2. On the other hand, in operation 460, the UE receives the second DCI indicating the sensing beam A; then in operation 480, the UE determines only TCI state 0 which is associated with sensing beam A, and then receives a new 2-layer PDSCH instead of the 4-layer PDSCH in slot C.

FIG. 5 illustrates a signaling flow chart 500 according to method 400. The BS transmits first DCI 510 to a UE for scheduling N P-layer PDSCH transmissions, herein P is an integer and equals to (P₀+P₁+ . . . +P_{(M-1)}). Then the BS performs LBT procedures with the at least two sensing beams, generates and transmits second DCI 520 to the UE if the LBT procedures generate success results with at least one sensing beam, herein DCI 520 indicates at least one sensing beam where the LBT procedures generate success result(s). Based on the results generated by the LBT procedures, the BS transmit N PDSCHs 530 at the time scheduled by first DCI 510.

For example, if the LBT procedures generate failure result(s) with at least one sensing beam, then the BS will generate N new PDSCH transmissions each having (P₀+P₁+ . . . +P_{(M-1)}−P_{failure}) layers, and transmits these N new PDSCH transmissions to the UE at the time scheduled by first DCI 510; in this example, N PDSCHs 530 are the N new PDSCH transmissions rather than the N P-layer PDSCH transmissions.

For example, if the LBT procedures with all the sensing beams generate success results, then the BS will transmit the N P-layer PDSCH transmissions to the UE at the time scheduled by first DCI 510; in this example, N PDSCHs 530 are the N P-layer PDSCH transmissions.

According to method 400 and the signaling flow chart 500 illustrated in FIG. 5, the second DCI (e.g., second DCI 520) indicates the sensing beams where the LBT procedures generate success results. Furthermore, the second DCI is generated after the LBT procedures are performed.

It would be appreciated there may be a variant of method 400. In the variant of method 400, the BS prepares M second DCIs each corresponding to the M TRPs respectively before completing the LBT procedures. If the LBT procedures generate success results with at least one sensing beam, after the LBT procedures, in the variant of method 400, in operation 450, the BS may transmit at least one second DCI from the corresponding TRP, each of the transmitted second DCIs indicates a sensing beam covering a Tx beam (e.g., indicates the TCI state corresponding to the sensing beam) where the LBT procedures generate success results. In the variant of method 400, in operation 460, the UE receives the at least one second DCI, and in the variant of method 400, in operation 480, the UE may determine the at least one TCI state according to the at least one received second DCI.

For example, referring back to FIG. 1 in combination with FIG. 4, according to the variant of method 400, in operation 410, in slot A, a BS transmits a first DCI (i.e., the DCI illustrated in FIG. 1) scheduling a 4-layer PDSCH transmission (N=1) in slot C from two TPRs (TRP 0 and TRP 1) (M=2) to a UE. The first DCI indicates two groups of DMRS ports for the PDSCH transmission, more specifically, group 0 of DMRS ports consists of DMRS port 0 and DMRS port 1 and group 1 of DMRS ports consists of DMRS port 2 and DMRS port 3. The first DCI also indicates TCI state 0 (corresponding to Tx beam A) and TCI state 1 (corresponding to Tx beam B). Herein, TRP 0 corresponds to TCI state 0 and group 0 of DMRS ports, and TRP 1 corresponds to TCI state 1 and group 1 of DMRS ports. Correspondingly, in operation 420, the UE receives the first DCI.

Before completing operation 430, according to the variant of method 400, the BS prepares two second DCIs (DCI0 and DCI1), wherein DCI0 corresponds to TRP 0, DCI1 corresponds to TRP 1.

In operation 430 during slot B, the BS performs directional LBT procedures on both sensing beam A and sensing beam B which cover Tx beam A and Tx beam B respectively, wherein Tx beam A and Tx beam B are used for the 4-layer PDSCH transmission.

If the directional LBT procedures with both the sensing beam A and the sensing beam B generate success results, then in operation 440, the BS determines that both Tx beam A and Tx beam B corresponding to the two TCI states can be used for the 4-layer PDSCH transmission; then according to the variant of method 400, in operation 450, the BS transmits the two second DCIs (DCI 0 indicating sensing beam A and DCI 1 indicating sensing beam B respectively) via TRP 0 and TRP 1 respectively; and in operation 470, the BS transmit the 4-layer PDSCH in slot C via TRP 0 and TRP 1. Correspondingly, according to the variant of method 400, in operation 460, the UE receives the two second DCIs, and then in operation 480, the UE determines TCI state 0 and TCI state 1 according to the received two second DCIs, and receives the 4-layer PDSCH in slot C. In this case, P_{failure} is 0.

If the directional LBT procedures with sensing beam A generate a success result while the directional LBT procedures with sensing beam B generate a failure result, then in operation 440, the BS may determine only Tx beam A corresponding to TCI state 0 can be used for PDSCH transmission, while Tx beam B corresponding to TCI state 1 cannot be used for PDSCH transmission, that is, the BS determines TCI state0, which is associated with the sensing beam A where LBT procedures generate a success results; then according to the variant of method 400, in operation 450, the BS transmits the DCI 0 indicating sensing beam A via TRP 0, and in operation 470, the BS generates a new 2-layer PDSCH and transmit the new 2-layer PDSCH instead of the 4-layer PDSCH in slot C from TRP 0; in this case, P_{failure} is 2. On the other hand, according to the variant of method 400, in operation 460, the UE receives the DCI0; then in operation 480, the UE determines only TCI state 0 according to second DCI0, and then receive a new 2-layer PDSCH rather than the 4-layer PDSCH in slot C.

According to the variant of method 400, there is a variant of the signaling flow chart 500, where second DCI 520 includes at least one second DCI, each of the at least one second DCI indicates a sensing beam.

The aforementioned method 400 and its variant introduce a second DCI or at least one second DCI notifying the UE with the result(s) generated by the LBT procedures. The UE may determine the at least one TCI state according to the at least one received second DCI.

The present disclosure provides another exemplary method 600 based on method 200 for multi-layer PDSCH transmission and reception via multiple TRPs on unlicensed bands.

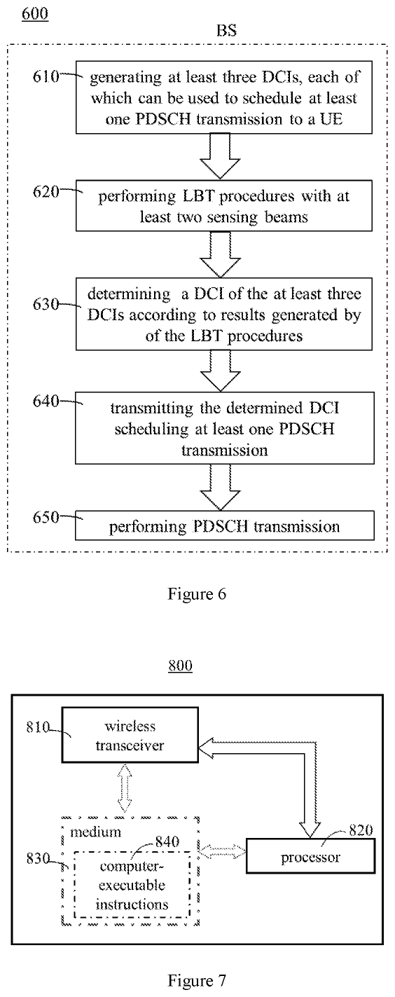

FIG. 6 illustrates an exemplary flowchart of method 600. In method 600, the BS performs LBT procedures before transmitting the first DCI; therefore, the UE does not need to know the result of the LBT procedures.

It would be appreciated that in method 600 or in other methods described later, the UE is not a special UE; it can be a generic device or an apparatus, or a part of a device or an apparatus that uses the technical solution of the present application.

It would be appreciated that in method 600 or in other methods described later, the BS is not a special BS; it can be a generic BS or even a part of a BS that uses the technical solution of the present application.

In operation 610, a BS generates at least three DCIs, each of which can be used to schedule at least one PDSCH transmission to a UE. The number of the DCIs generated by the BS is related to the number of TRPs. Among the at least three DCIs, there is a first DCI which indicates at least two groups of DMRS ports corresponding to at least two TRPs, and indicates at least two TCI states corresponding to at least two Tx beams for the at least one PDSCH transmission.

In operation 620, the BS performs LBT procedures with at least two sensing beams covering the at least two Tx beams.

In operation 630, the BS determines a DCI of the at least three DCIs according to results generated by the LBT procedures.

In operation 640, the BS transmits the determined DCI scheduling at least one multi-layer PDSCH; herein the determined DCI indicates at least one TCI state, and indicates at least one group of DMRS ports corresponding to the at least one TRP. In operation 650, the BS transmits the at least one multi-layer PDSCH at the time scheduled by the determined DCI.

For example, referring back to FIG. 1 in combination with FIG. 6, in operation 610, a BS generates three DCIs, that is, DCI 0 scheduling a 4-layer PDSCH transmission from two TPRs (TRP 0 and TRP 1) to a UE, DCI 1 scheduling a 2-layer PDSCH transmission from TRP 0 to the UE, and DCI 2 scheduling a 2-layer PDSCH transmission from TRP 1 to the UE. The DCI 0 indicates two groups of DMRS ports for the PDSCH transmission, more specifically, group 0 of DMRS ports consists of DMRS port 0 and DMRS port 1, and group 1 of DMRS ports consists of DMRS port 2 and DMRS port 3. The DCI 0 also indicates TCI state 0 (corresponding to Tx beam A) and TCI state 1 (corresponding to Tx beam B). Herein, TRP 0 corresponds to TCI state 0 and group 0 of DMRS ports, and TRP 1 corresponds to TCI state 1 and group 1 of DMRS ports.

In operation 620, the BS performs directional LBT procedures with both sensing beam A and sensing beam B which cover Tx beam A and Tx beam B respectively.

If the directional LBT procedures with both the sensing beam A and the sensing beam B generate success results, then in operation 630, the BS determines that DCI 0 can be transmitted to schedule a 4-layer PDSCH transmission from two TPRs; then in operation 640, the BS transmits the DCI 0; and in operation 650, the BS transmits the 4-layer PDSCH via TRP 0 and TRP 1.

If the directional LBT procedures with sensing beam A generate a success result while the directional LBT procedures with sensing beam B generate a failure result, then in operation 620, the BS may determine that DCI 1 can be transmitted to schedule a 2-layer PDSCH transmission from TPR 0; then in operation 640, the BS transmits the DCI 1; and in operation 650, the BS transmits the 2-layer PDSCH via TRP 0.

It would be appreciated in the provided methods and embodiments provided by the present disclosure (e.g., method 200, method 300, method 400, and method 600), the number of each operation does not represent the order of execution.

Based on the above description, the present disclosure provides various method for a UE to determine that a BS may transmit a new PDSCH transmission due to the LBT failure.

According to the present disclosure, comparing to the PDSCH transmission scheduled in the first DCI, new PDSCH transmission is re-generated by reducing some layers due to the LBT procedures generate failure result(s) with at least one sensing beam.

Furthermore, according to the present disclosure, various methods are provided for indicating the directional LBT result(s) to the UE.

According to the present disclosure, even if LBT procedures with some sensing beams generate failure results, the UE still has the capability to receive PDSCH(s) with less layers at the scheduled time.

FIG. 7 illustrates a simplified block diagram of an exemplary apparatus 800 according to various embodiments of the present disclosure. Apparatus 800 may be or include at least a part of a UE or similar device having similar functionality.

As shown in FIG. 7, apparatus 800 may include at least wireless transceiver 810 and processor 820, wherein wireless transceiver 810 may be coupled to processor 820. Furthermore, apparatus 800 may include non-transitory computer-readable medium 830 with computer-executable instructions 840 stored thereon, wherein non-transitory computer-readable medium 830 may be coupled to processor 820, and computer-executable instructions 840 may be configured to be executable by processor 820. In some embodiments, wireless transceiver 810, non-transitory computer-readable medium 830, and processor 820 may be coupled to each other via one or more local buses.

Although in FIG. 7, elements such as wireless transceiver 810, non-transitory computer-readable medium 830, and processor 820 are described in the singular, the plural is contemplated unless limitation to the singular is explicitly stated. In some embodiments of the present disclosure, the wireless transceiver 810 may be configured for wireless communication. In some embodiments of the present disclosure, wireless transceiver 810 can be integrated into a transceiver. In certain embodiments of the present disclosure, the apparatus 800 may further include other components for actual usage.

Processor 820 is configured to cause the apparatus 800 at least to perform, with wireless transceiver 810, any one of the various methods (e.g., method 200) and embodiments described above which are performed by a UE according to the present disclosure.

According to the present disclosure, processor 820 is configured to, with wireless transceiver 810, receive a first DCI scheduling at least one PDSCH reception including a first PDSCH reception from a BS, wherein the first DCI indicates at least two groups of DMRS ports and at least two TCI states for the at least one PDSCH reception; and determining at least one TCI state of the at least two TCI states, wherein the at least one TCI state is associated with at least one sensing beam where LBT procedures performed by the BS generate a success result.

In some embodiments, processor 820 is further configured to, with wireless transceiver 810, perform a second PDSCH reception instead of the first PDSCH reception based on the determined at least one TCI state.

In some embodiments, the LBT procedures are performed by the BS with at least two sensing beams associated with the at least two TCI states. In some embodiments, to determine the at least one TCI state, processor 820 is further configured to, with wireless transceiver 810,: detect PDSCH transmission based on the at least two TCI states, and determine the at least one TCI state of the at least two TCI states based on the detection.

In some embodiments, to determine the at least one TCI state, processor 820 is further configured to, with wireless transceiver 810, receive a second DCI and determine the at least one TCI state based on the second DCI.

In some embodiments, the second DCI is generated by the BS after the LBT is performed by the BS.

In some embodiments, the second DCI indicates the at least one sensing beam where the LBT procedures performed by the BS generate a success result.

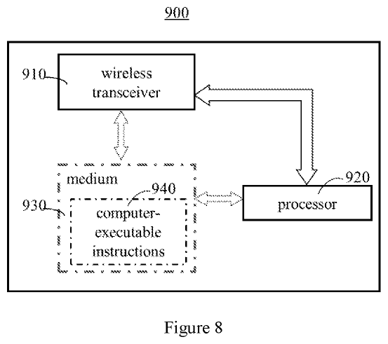

FIG. 8 illustrates a simplified block diagram of an exemplary apparatus 900 according to various embodiments of the present disclosure. Apparatus 900 may be a BS, or include at least a part of a BS, or a device having similar functionality.

As shown in FIG. 8, apparatus 900 may include at least wireless transceiver circuitry 910 and processor 920, wherein wireless transceiver 910 may be coupled to processor 920. Furthermore, apparatus 900 may include non-transitory computer-readable medium 930 with computer-executable instructions 940 stored thereon, wherein non-transitory computer-readable medium 930 may be coupled to processor 920, and computer-executable instructions 940 may be configured to be executable by processor 920. In some embodiments, wireless transceiver 910, non-transitory computer-readable medium 930, and processor 920 may be coupled to each other via one or more local buses.

Although in FIG. 8, elements such as wireless transceiver 910, non-transitory computer-readable medium 930, and processor 920 are described in the singular, the plural is contemplated unless limitation to the singular is explicitly stated. In some embodiments of the present disclosure, the wireless transceiver 910 may be configured for wireless communication. In some embodiments of the present disclosure, wireless transceiver 910 can be integrated into a transceiver. In certain embodiments of the present disclosure, the apparatus 900 may further include other components for actual usage.

Processor 920 is configured to cause the apparatus 900 at least to perform, with wireless transceiver 910, any one of the various methods (e.g., method 600) and embodiments described above which are performed by a BS according to the present disclosure.

According to the present disclosure, processor 920 is configured to, with wireless transceiver 910, transmit a first DCI scheduling at least one PDSCH transmission including a first PDSCH transmission to a UE, wherein the first DCI indicates at least two groups of DMRS ports and at least two TCI states for the at least one PDSCH transmission; perform LBT procedures with at least two sensing beams after the transmission of the first DCI, wherein the at least two sensing beams are associated with the at least two TCI states; and determine at least one TCI state of the at least two TCI states that is associated with at least one sensing beam where LBT procedures generate a success result.

In some embodiments, the processor 920 is further configured to, with wireless transceiver 910, perform a second PDSCH transmission instead of the first PDSCH transmission based on the determined at least one TCI state.

In some embodiments, processor 920 is further configured to, with wireless transceiver 910, transmit a second DCI, wherein the second DCI indicates the at least one sensing beam where the LBT procedures generate a success result.

In some embodiments, processor 920 is further configured to generate the second DCI after performing the LBT.

In some embodiments, the second DCI indicates the at least one sensing beam where the LBT procedures generate a success result.

In various example embodiments, processors 820 or 920 may include, but is not limited to, at least one hardware processor, including at least one microprocessor such as a CPU, a portion of at least one hardware processor, and any other suitable dedicated processor such as those developed based on for example Field Programmable Gate Array (FPGA) and Application Specific Integrated Circuit (ASIC). Further, processors 820 or 920 may also include at least one other circuitry or element not shown in FIG. 7 or FIG. 8.

In various example embodiments, non-transitory computer-readable mediums 830 or 930 may include at least one storage medium in various forms, such as a volatile memory and/or a non-volatile memory. The volatile memory may include, but is not limited to, for example, an RAM, a cache, and so on. The non-volatile memory may include, but is not limited to, for example, an ROM, a hard disk, a flash memory, and so on. Further, non-transitory computer-readable mediums 830 or 930 may include, but is not limited to, an electric, a magnetic, an optical, an electromagnetic, an infrared, or a semiconductor system, apparatus, or device or any combination of the above.

Further, in various example embodiments, exemplary apparatus 800 or 900 may also include at least one other circuitry, element, and interface, for example antenna element, and the like.

In various example embodiments, the circuitries, parts, elements, and interfaces in exemplary apparatus 800 or 900, including processor 820 or 920 and non-transitory computer-readable mediums 830 or 930, may be coupled together via any suitable connections including, but not limited to, buses, crossbars, wiring and/or wireless lines, in any suitable ways, for example electrically, magnetically, optically, electromagnetically, and the like.

The methods of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

The terms “includes,” “comprising,” “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “including,” “having,” and the like, as used herein, are defined as “comprising.”

What is claimed is:

1. A method performed by a user equipment (UE), comprising:
receiving a first downlink control information (DCI) scheduling at least one physical downlink shared channel (PDSCH) reception including a first PDSCH reception from a base station (BS), wherein the first DCI indicates at least two groups of demodulation reference signal (DMRS) ports and at least two transmission configuration indication (TCI) states for the first PDSCH reception; and
determining at least one TCI state of the at least two TCI states, wherein the at least one TCI state is associated with at least one sensing beam.

2. The method of claim 1, further comprising performing a second PDSCH reception instead of the first PDSCH reception based on the determined at least one TCI state.

3. (canceled)

4. The method of claim 1, wherein determining the at least one TCI state further comprises:
detecting PDSCH transmission based on the at least two TCI states; and
determining the at least one TCI state of the at least two TCI states based on the detection of the PDSCH transmission.

5. The method of claim 1, wherein determining the at least one TCI state further comprises:
receiving a second DCI; and
determining the at least one TCI state based on the second DCI.

6. The method of claim 5, wherein the second DCI indicates the at least one sensing beam.

7. A user equipment (UE) for wireless communication, comprising:
at least one memory; and
at least one processor coupled with the at least one memory and configured to cause the UE to:
receive a first downlink control information (DCI) scheduling at least one physical downlink shared channel (PDSCH) reception including a first PDSCH reception from a base station (BS), wherein the first DCI indicates at least two groups of demodulation reference signal (DMRS) ports and at least two transmission configuration indication (TCI) states for the first PDSCH reception; and
determine at least one TCI state of the at least two TCI states, wherein
the at least one TCI state is associated with at least one sensing beam.

8. The UE of claim 7, wherein the at least one processor is configured to cause the UE to perform a second PDSCH reception instead of the first PDSCH reception based on the determined at least one TCI state.

9. (canceled)

10. The UE of claim 7, wherein to determine the at least one TCI state, the processor is further configured to cause the UE to:
detect PDSCH transmission based on the at least two TCI states; and
determine the at least one TCI state of the at least two TCI states based on the detection of the PDSCH transmission.

11. The UE of claim 7, wherein to determine the at least one TCI state, the processor is further configured to cause the UE to:
receive a second DCI; and
determine the at least one TCI state based on the second DCI.

12. The UE of claim 11, wherein the second DCI indicates the at least one sensing beam.

13. A base station (BS) for wireless communication, comprising:
at least one memory; and
at least one processor coupled with the at least one memory and configured to cause the BS to:
transmit a first downlink control information (DCI) scheduling at least one physical downlink shared channel (PDSCH) transmission including a first PDSCH transmission to a UE, wherein the first DCI indicates at least two groups of demodulation reference signal (DMRS) ports and at least two transmission configuration indication (TCI) states for the first PDSCH transmission;
perform LBT procedures with at least two sensing beams after the transmission of the first DCI, wherein the at least two sensing beams are associated with the at least two TCI states; and
determine at least one TCI state of the at least two TCI states that is associated with at least one sensing beam where listen-before-transmit (LBT) procedures generate a success result.

14. The BS of claim 13, wherein the at least one processor is configured to cause the BS to perform a second PDSCH transmission instead of the first PDSCH transmission based on the determined at least one TCI state.

15. The BS of claim 13, wherein the at least one processor is configured to cause the BS to transmit a second DCI, wherein the second DCI indicates the at least one sensing beam where the LBT procedures generate a success result.

16. The UE of claim 7, wherein the at least one processor is configured to cause the UE to determine a success result of a listen-before-talk (LBT) procedure based at least in part on the first PDSCH reception.

17. A processor for wireless communication, comprising:
at least one controller coupled with at least one memory and configured to cause the processor to:
receive a first downlink control information (DCI) scheduling at least one physical downlink shared channel (PDSCH) reception including a first PDSCH reception from a base station (BS), wherein the first DCI indicates at least two groups of demodulation reference signal (DMRS) ports and at least two transmission configuration indication (TCI) states for the first PDSCH reception; and
determine at least one TCI state of the at least two TCI states, wherein the at least one TCI state is associated with at least one sensing beam.

18. The processor of claim 17, wherein the at least one controller is configured to cause the processor to perform a second PDSCH reception instead of the first PDSCH reception based on the determined at least one TCI state.

19. The processor of claim 17, wherein to determine the at least one TCI state, the at least one controller is configured to cause the processor to:
detect PDSCH transmission based on the at least two TCI states; and
determine the at least one TCI state of the at least two TCI states based on the detection of the PDSCH transmission.

20. The processor of claim 17, wherein to determine the at least one TCI state, the at least one controller is configured to cause the processor to:
receive a second DCI; and
determine the at least one TCI state based on the second DCI.

21. The processor of claim 20, wherein the second DCI indicates the at least one sensing beam.

22. The processor of claim 17, wherein the at least one controller is configured to cause the processor to determine a success result of a listen-before-talk (LBT) procedure based at least in part on the first PDSCH reception.
